(19) United States
(12) Patent Application Publication
(10) Pub. No.: US 2014/0333977 A1
(43) Pub. Date: Nov. 13, 2014

(54) DISPLAY DEVICE

(71) Applicant: Electronics and Telecommunications Research Institute, Daejeon (KR)

(72) Inventors: Chi-Sun HWANG, Daejeon (KR); Hye Yong CHU, Daejeon (KR); Jong Sool JEONG, Daejeon (KR)

(73) Assignee: Electronics and Telecommunications Research Institute, Daejeon (KR)

(21) Appl. No.: 14/212,162

(22) Filed: Mar. 14, 2014

(30) Foreign Application Priority Data
May 10, 2013 (KR) 10-2013-0053306
Oct. 23, 2013 (KR) 10-2013-0126490

(51) Int. Cl. G03H 1/22

(52) U.S. Cl. CPC G03H 1/2294; Y10S 977/774; Y10S 977/95; B82Y 20/00
USPC 359/9; 977/774; 977/950

(57) ABSTRACT

Provided is a display device. The display device includes a backlight unit generating a plurality of flat lights and a spatial light modulator (SLM) unit generating an interference pattern by using the plurality of lights according to hologram data and displaying a hologram based on the generated interference pattern. The backlight unit is manufactured as an organic light emitting diode including a plurality of quantum dots.

### CROSS-REFERENCE TO RELATED APPLICATIONS

This U.S. non-provisional patent application claims priority under 35 U.S.C. §119 of Korean Patent Application Nos. 10-2013-0053306, filed on May 10, 2013, and 10-2013-0126490, filed on Oct. 23, 2013, the entire contents of which are hereby incorporated by reference.

### BACKGROUND OF THE INVENTION

The present invention disclosed herein relates to a display device, and more particularly, to a display device using holography.

Recently, researches on three-dimensional images and image reproducing technologies have been performed. General two-dimensional image systems provide flat images. Three-dimensional image systems use an image realization technology of showing an observer actual image information of an object. As an example of reproducing a three-dimensional image, in case of holography, there is used a theory, in which an interference signal obtained by overlapping a light reflected by an object, which is referred to as an object wave with a coherent light, which is referred to as a reference wave, is recorded and reproduced.

A hologram is obtained by recording interference fringes formed by overlapping an object wave colliding with an object and scattered with a reference wave incident from another direction on a photographic film. In this case, the hologram uses a highly coherent laser beam. As described above, when the object wave is overlapped with the reference wave, the interference fringes are formed due to interference. Amplitude and phase information of the object is recorded on the interference fringes. Three-dimensional properties recorded on the hologram is restored as a three-dimensional image by sending a reference light to the interference fringes recorded as described above, which is referred to as holography.

Generally, since a hologram system using a laser that is a point light source needs a plurality of optical components, it is difficult to miniaturize the same. Legibility according to a size and image quality is determined by a spatial light modulator (SLM). In order to increase the legibility, an SLM having a high degree of integration of pixels is necessary. In order to provide a hologram while maintaining a thin bezel such as a mobile device and television recently used, an SLM capable of being miniaturized and having excellent legibility is necessary.

Recently, various hologram systems have been developed. Generally, as a light source of a hologram system, a laser that is a point light source is used. However, a laser-based point light source needs a plurality of optical components to provide a hologram. Due to the plurality of optical components, hologram systems are difficult to be miniaturized. Additionally, when a degree of integration of pixels is not high, a viewing angle of a hologram system becomes smaller. Accordingly, it is necessary to provide hologram systems capable of reducing optical components while increasing a viewing angle.

### SUMMARY OF THE INVENTION

The present invention provides a display device manufactured to have a small thickness and an improved viewing angle.

Embodiments of the present invention provide display devices including a backlight unit generating a plurality of flat lights and a spatial light modulator (SLM) unit generating an interference pattern by using the plurality of lights according to hologram data and displaying a hologram based on the generated interference pattern. The backlight unit is manufactured as an organic electric field light emitting diode based on a plurality of quantum dots.

### BRIEF DESCRIPTION OF THE DRAWINGS

The accompanying drawings are included to provide a further understanding of the present invention, and are incorporated in and constitute a part of this specification. The drawings illustrate exemplary embodiments of the present invention and, together with the description, serve to explain principles of the present invention. In the drawings:

FIG. 1 is a block diagram illustrating a display device according to an embodiment of the present invention;

FIG. 2 is a cross-sectional view of a backlight unit shown in FIG. 1;

FIG. 3 is a circuit diagram illustrating a pixel of a driving unit shown in FIG. 1; and

FIG. 4 is a cross-sectional view of the driving unit shown in FIG. 1.

### DETAILED DESCRIPTION OF PREFERRED EMBODIMENTS

Since embodiments of the present invention may have various modifications and several shapes, exemplary embodiments will be shown in the drawings and will be described in detail. However, this is not to limit the inventive concept to the exemplary embodiments but should be understood as including all modifications, equivalents, and substitutes included in the spirits and scope of the inventive concept.

Throughout the respective drawings, like reference numerals designate like elements. In the attached drawings, sizes of structures are more enlarged than they actually are for clarity of the inventive concept. It will be understood that although the terms “first”, “second”, etc. may be used herein to describe various elements, these elements should not be limited by these terms. These terms are only used to distinguish one element from another. For example, within the scope of the present invention, a first element may be designated as a second element, and similarly, the second element may be designated as the first element. Singular expressions, unless defined otherwise in contexts, include plural expressions.

In the present specification, terms “comprise” or “have” are used to designate features, numbers, steps, operations, elements, components or combinations thereof disclosed in the specification as being present but not to exclude possibility of the existence or the addition of one or more other features, numbers, steps, operations, elements, components, or combinations thereof. Also, when it is described that a part such as a layer, a film, an area, and a plate is “on” another part, this includes not only a case, in which the part is “directly on” the other part, but also a case, in which still another part is disposed therebetween. On the contrary, when it is described that a part such as a layer, a film, an area, and a plate is “under” another part, this includes not only a case, in which the part is “directly under” the other part, but also a case, in which still another part is disposed therebetween.

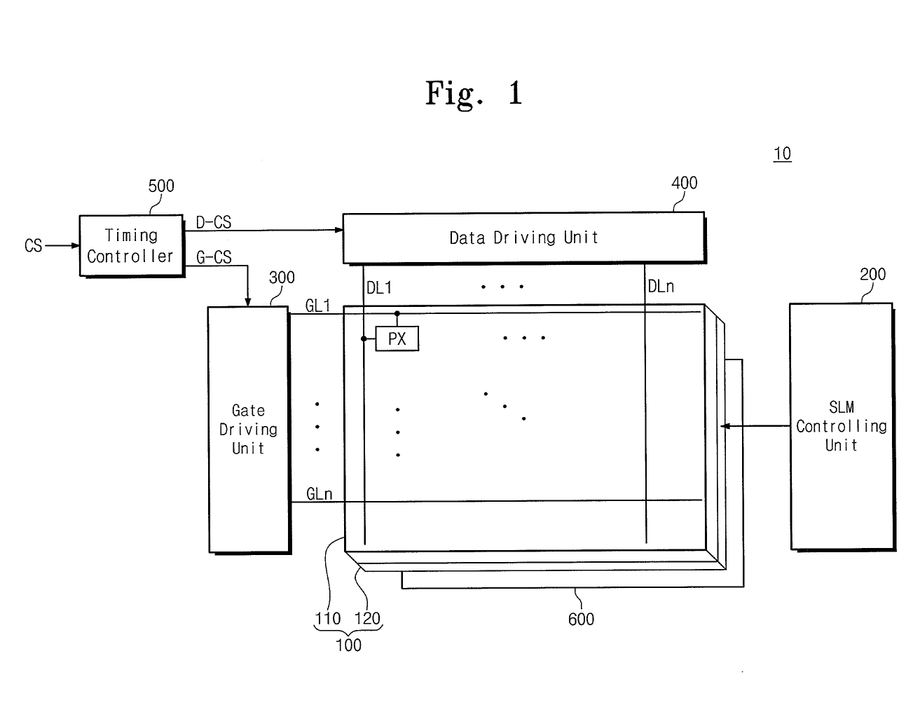

FIG. 1 is a block diagram illustrating a display device 10 according to an embodiment of the present invention. Referring to FIG. 1, the display device 10 includes a spatial light modulator (SLM) unit 100, an SLM controlling unit 200, a gate driving unit 300, a data driving unit 400, a timing controller 500, and a backlight unit 600.

The SLM unit 100 displays an image. In this case, the image indicates a hologram. In detail, the SLM unit 100 includes a driving part 110 transferring an image signal and a light modulator 120 displaying interference fringes of a hologram.

The driving part 110 includes a plurality of gate lines GL1 to GLn, a plurality of data lines DL1 to DLn, and a plurality of pixels PXs. The plurality of gate lines GL1 to GLn are disposed to be extended in a line direction to intersect with the plurality of data lines DL1 to DLn extended in a row direction.

The plurality of pixels PX are connected to corresponding gate lines and data lines, respectively. For example, a pixel PX connected to a first gate line GL1 and a first data line DL1 is shown in FIG. 1. Also, other pixels PXs are connected to corresponding gate lines and data lines, respectively.

The light modulator 120 is located on a rear side of the driving part 110 and spatially modulates a light. That is, light modulator 120 may control amplitude and phase by switching, blanking, or modulating beams of one or a plurality of independent light sources. The amplitude designates a gradation of brightness and darkness of an image, and the phase designates a position of an object shown in the image, that is, a distance between eyes of a human and the object. The light modulator 120 may reconfigure object points displayed in the image by changing the amplitude and phase of the light passing through the plurality of pixels PX.

In detail, the light modulator 120 diffracts or focuses light incident from the backlight unit 600 according to a certain wavelength. The light modulator 120 includes a diffracting grating capable of diffracting the light incident from the backlight unit 600 by controlling an incident angle of the light.

Also, the light modulator 120 may operate while being connected to the SLM controlling unit 200. The light modulator 120 may generate interference fringes according to hologram data provided from the SLM controlling unit 200. A light generated according to the interference fringes generated by the light modulator 120 is diffused toward the eyes of a user and is embodied as a three-dimensional image.

The SLM controlling unit 200 generates an image, that is, hologram data for driving a hologram. The SLM controlling unit 200 transfers the generated hologram data to the light modulator 120 to allow the interference fringes to be displayed by the light modulator 120.

The gate driving unit 300, in response to a gate control signal G-CS provided from the timing controller 500, sequentially outputs gate signals to the plurality of gate lines GL1 to GLn. The pixels PXs may be sequentially scanned by a unit line by the gate signals.

The data driving unit 400 converts and outputs image signals into voltages in response to data control signal D-CS provided from the timing controller 500. The outputted data voltages are applied to the driving part 110 through the plurality of data lines DL1 to DLn.

A plurality of pixels PXs, in response to the gate signals, are provided with data voltages. The plurality of pixels PXs display gradations corresponding to the data voltages. Accordingly, an image is displayed.

The timing controller 500 receives a plurality of image signals and a plurality of control signals CS from the outside of the display device 10. The timing controller 500 converts data formats of the image signals to fit interface specifications of the data driving unit 400. The image signals whose data formats are converted are provided to the data driving unit 400.

The timing controller 500, in response to the control signals CS, generates the data control signals D-CS and gate control signals G-CS. For example, the data control signal D-CS may include an output initiation signal and a horizontal initiation signal. The gate control signal G-CS may include a vertical initiation signal and a vertical clock-bar signal.

The backlight unit 600 is located in a rear of the SLM unit 100 and supplies a light source to the SLM unit 100. For example, as a general backlight unit, a laser light source that is a point light source is used. The laser light source needs a lot of optical components to provide a front surface of the light modulator 120 with light. Due thereto, a thickness of the display device 10 can not become thinner.

In the embodiment, the backlight unit 600 uses a large-area light source device based on a quantum dot light emitting diode (QD-LED). That is, the backlight unit may generate flat lights and may provide the SLM unit 100 with the same. The QD-LED-based backlight unit 600 may be manufactured to have a size according to the SLM unit 100.

Also, the QD-LED is a spontaneous emission device and does not need additional optical devices for providing the front surface of the light modulator 120 with light. Accordingly, an overall thickness of the display device 10 may become thinner. That is, when the QD-LED light source is used instead of a laser light source, the thickness of the display device 10 may become thinner.

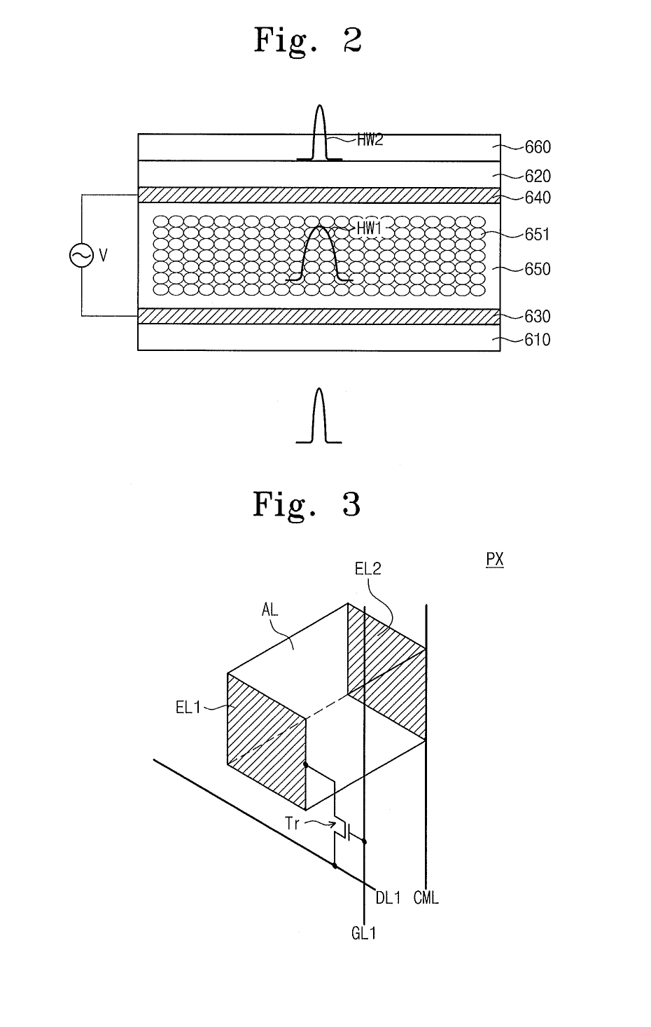

FIG. 2 is a cross-sectional view of the backlight unit 600. Generally, an organic light emitting diode (OLED) light source may be used as a spontaneous emission device but has a limitation of having an optical wavelength with a larger half width compared with the laser light source that is the point light source. That is, the half-width of a wavelength of light outputted from the OLED light source has a limitation of being larger than a half-width of a wavelength of light necessary for driving the hologram system.

Referring to FIG. 2, the backlight unit 600 uses a QD-LED light source that is the spontaneous emission device. A QD is a semiconductor material having a nano size and providing a quantum confinement effect. The QD, when receiving light from an excitation source and being allowed to excite energy, spontaneously emits energy according to a corresponding energy band gap. Accordingly, the backlight unit 600 controls a size of the QD, thereby providing a narrow spectrum line width of about 40 nm or less based on a full width at a half maximum (FWHM).

In detail, the backlight unit 600 based on the QD-LED light source includes a first substrate 610, a second substrate 620, an anode 630, a cathode 640, an emission layer 650, a plasmon nanohole array 660, and a power source V.

The anode 630 is disposed on the first substrate 610, and the cathode 640 is disposed on the second substrate 620. The power source V is electrically connected to the anode 630 and the cathode 640 and generates an electric field between the anode 630 and the cathode 640. The emission layer 650 is disposed between the anode 630 and the cathode 640, and a plurality of QDs 651 are disposed on the emission layer 650. The emission layer 650, in response to the electric field generated from the anode 630 and cathode 640, emits light outward.

Also, in the embodiment, the backlight unit 600 includes the plasmon nanohole array 660. Generally, plasmon means quasi particles, in which free electrons in metal collectively oscillate. Plasmons are locally disposed on a surface of a nanohole array formed of metallic nano particles.

For example, when a visible ray applied from the outside or an electric field of near-infrared rays is combined with plasmons, light absorption occurs at the metallic nano particles. That is, light energy is absorbed into plasmons and accumulated on a surface of a metallic nano particle. Due to the light energy accumulated on the surface of the metallic nano particle, a wavelength of light emitted outward may be controlled. For example, nano particles having a diameter of from about 250 nm to about 350 nm may be arranged on the plasmon nanohole array 660.

The plasmon nanohole array 660 is disposed on the second substrate 620 and may more reduce a half-width of a wavelength of light emitted from the emission layer 650. For example, the half-width of the wavelength of light outputted from the emission layer 650 is referred to as a first half-width HW1 and a half-width of a wavelength of light outputted through the plasmon nanohole array 660 is referred to as a second half-width HW2. The half-width of the wavelength of light outputted from the emission layer 650, that is, the first half-width HW1 may be reduced to a wideness of the second half-width while passing through the plasmon nanohole array 660.

FIG. 3 is a circuit diagram illustrating the pixel PX of the driving part 110. Referring to FIG. 3, the pixel PX may be any one of the plurality of pixels PXs included in the driving part 110. The pixel PX may be connected to the first gate line GL1 and the first data line DL1.

In detail, the pixel PX connected to the first gate line GL1 and the first data line DL1 includes a first electrode ELL a second electrode EL2, and a thin film transistor Tr, and an active layer AL. In this case, the first electrode EL1 may be a pixel electrode PE and the second electrode EL2 may be a common layer CE.

The thin film transistor Tr includes a gate electrode connected to the first gate line GL1, a source electrode connected to the first data line DL1, and a drain electrode connected to the first electrode EL1. The thin film transistor Tr, in response to a gate signal applied to the first gate line GL1, transmits a data signal applied to the first data line DL1 to the first electrode ELL The first electrode EL1 in response to the data signal, may form an electric field. The second electrode EL2, in response to a common signal connected to a common line CML, forms an electric field. In response to the electric field formed between the first and second electrodes EL1 and EL2 as described above, light may be modulated by the active layer AL.

Also, generally, in order to reproduce a hologram, a driving part with high pixel integration is necessary. That is, as a degree in integration of pixels included in the driving part is higher, a viewing angle of the hologram may increase.

In the embodiment, the active layer AL may be a thermo-optical polymer or an electro-optical polymer. An optical polymer material emits light according to fundamental physical properties and does not need additional processing elements for modulation such as a liquid crystal. That is, as a manufacturing process becomes simplified, a degree of integration of pixels may increase.

Also, as the optical polymer material is used, the pixel PX may control a refractive index of light in response to a temperature or the intensity of an electric field. For example, a voltage is applied to a polymer, thereby controlling a refractive index of light passing through the pixel PX. Also, a voltage applied between the first electrode layer EL1 and the second electrode layer EL2 is controlled, thereby controlling the refractive index of light passing through the pixel PX. As described above, the refractive index of light is controlled, thereby controlling a phase of the light passing through the pixel PX.

As described above, since the optical polymer material is used as the active layer AL, the integration of pixels PX provided to the SLM unit 100 may increase.

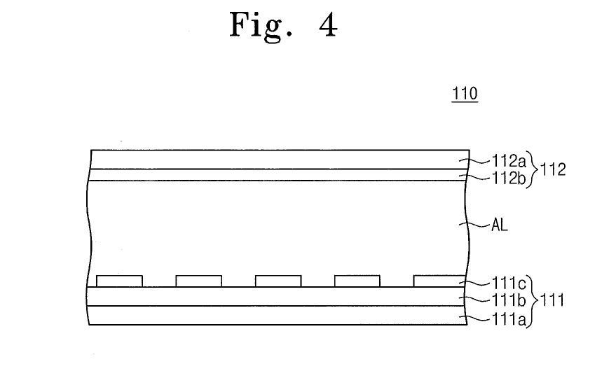

FIG. 4 is a cross-sectional view of the driving part 110. Referring to FIG. 4, the driving part 110 includes a first substrate 111, a second substrate 112, and an active layer AL.

The first substrate 111 includes a first base substrate 111a, an insulating layer 111b, and a plurality of pixel electrodes 111c. The insulating layer 111b is disposed on the first base substrate 111a, and the plurality of pixel electrodes 111c corresponding to a plurality of pixels PX are disposed on the insulating layer 111b. For example, the pixel electrodes 111c may be formed of transparent conductive oxides (TCOs). The TCO may be formed of a conductive metal oxide such as indium tin oxide (ITO) and indium zinc oxide (IZO).

Also, the first substrate 111 may be defined as a thin film transistor substrate. Referring to FIGS. 3 and 4, a pixel PX, a gate line GL, and a data line DL may be disposed on the first substrate 111. The pixel PX includes a thin film transistor Tr connected to the corresponding gate line GL and data line DL and pixel electrodes EL1 and 111c connected to the thin film transistor Tr.

The second substrate 112 includes a second base substrate 112a and a common electrode layer 112b. The common electrode layer 112b is disposed on the second base substrate 112a. The common electrode 112b receives a common voltage from the common line CML. An electric field corresponding to a voltage level difference between the common voltage and a data voltage is formed between the common electrode 112b receiving the common voltage and the pixel electrode 111c receiving the data voltage. The active layer AL may be driven by the electric field. In this case, the active layer AL may be formed of an optical polymer material.

For example, the common electrode 112b may be formed of TCO. As the TCO may be formed of a conductive metal oxide such as ITO, IZO, and indium tin zinc oxide (ITZO).

As described above, each pixel included in the driving part 110 uses the optical polymer material as the active layer AL. Accordingly, the integration of pixels included in the driving unit 110 may increase. Also, a phase of light is controlled according to a temperature or the intensity of an electric field, thereby controlling the amplitude of a hologram.

According to the embodiments of the present invention, a display device having an increased viewing angle and manufactured to have a small thickness may be provided.

The above-disclosed subject matter is to be considered illustrative, and not restrictive, and the appended claims are intended to cover all such modifications, enhancements, and other embodiments, which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. A display device comprising:
a backlight unit generating a plurality of flat lights; and
a spatial light modulator (SLM) unit generating an interference pattern by using the plurality of flat lights according to hologram data and displaying a hologram based on the generated interference pattern,
wherein the backlight unit is manufactured as an organic light emitting diode including a plurality of quantum dots.

2. The display device of claim 1, wherein the SLM unit comprises:
a light modulator driving the interference pattern according to the hologram data; and
a driving part disposed on the light modulator and displaying the hologram in response to the interference pattern.

3. The display device of claim 2, wherein the driving part comprises:
a first substrate, on which a plurality of pixels are disposed;
a second substrate facing the first substrate; and
an active layer disposed between the first substrate and the second substrate, and
wherein the active layer comprises a polymer material.

4. The display device of claim 3, wherein the active layer is formed of a thermo-optical polymer.

5. The display device of claim 3, wherein the active layer is formed of an electro-optical polymer.

6. The display device of claim 3, wherein the first substrate comprises:
a first base substrate;
an insulating layer disposed on the first base substrate; and
a first electrode disposed on the insulating layer and corresponding to the plurality of pixels.

7. The display device of claim 3, wherein the second substrate comprises:
a second base substrate; and
a second electrode disposed on the second base substrate.

8. The display device of claim 1, wherein the backlight unit comprises:
a first substrate;
an anode layer disposed on the first substrate;
a second substrate facing the first substrate;
a cathode layer disposed on the second substrate; and
an emission layer disposed between the anode layer and the cathode layer, and
wherein the plurality of quantum dots are disposed on the emission layer.

9. The display device of claim 8, wherein the backlight unit further comprises a power source electrically connected to the anode layer and cathode layer and applying a voltage thereto.

10. The display device of claim 8, wherein the backlight unit further comprises a plasmonic nanohole array disposed on the second substrate.

11. The display device of claim 10, wherein the plasmonic nanohole array comprises a plurality of nano holes and a half-width of light emitted from the emission layer is reduced based on the plurality of nano holes.

12. The display device of claim 1, wherein the backlight unit is manufactured to have a size identical to the SLM unit.
